(19) United States
(12) Patent Application Publication
(10) Pub. No.: US 2025/0003862 A1
(43) Pub. Date: Jan. 2, 2025

(54) RESIN MOLDED ARTICLE AND DETERMINING METHOD

(71) Applicant: Tsugunao TOYOOKA, TOKYO (JP)

(72) Inventor: Tsugunao TOYOOKA, TOKYO (JP)

(21) Appl. No.: 18/755,708

(22) Filed: Jun. 27, 2024

(30) Foreign Application Priority Data
Jun. 30, 2023 (JP) 2023-108157

(51) Int. Cl. G01N 17/04

(52) U.S. Cl. CPC G01N 17/043

(57) ABSTRACT

A resin molded article includes a body having a first discolor speed discolored by deterioration of the body, and a discoloring portion in the body and having a second discolor speed faster than the first discolor speed discolored by deterioration of a discoloring portion.

### CROSS-REFERENCE TO RELATED APPLICATIONS

This patent application is based on and claims priority pursuant to 35 U.S.C. § 119 (a) to Japanese Patent Application No. 2023-108157, filed on Jun. 30, 2023, in the Japan Patent Office, the entire disclosure of which is hereby incorporated by reference herein.

### BACKGROUND

### Technical Field

Embodiments of the present disclosure relate to a resin molded article made of a predetermined resin material such as a component of an apparatus, and a determining method for deterioration of the resin molded article.

### Related Art

In the related art, in various apparatuses (e.g., industrial products), a resin molded article (i.e., resin parts) made of a predetermined resin material has been used as a component. After such a resin molded article has finished its service in the market and is collected from the market, the degree of deterioration of the resin molded article is determined in a recycling factory, and the possibility of reuse is determined according to the degree of deterioration.

On the other hand, in the related art, a technique in which an electronic tag storing information on a resin molded article is embedded in the resin molded article and the embedded position is colored so as to be specified for the purpose of increasing the efficiency of a reproducing process of the resin molded article is known.

In the related art, the deterioration of the resin molded article cannot be determined without time and effort. On the other hand, the technique in the related art described above is for acquiring information of a resin molded article from an electronic tag embedded in the resin molded article or storing necessary information in the electronic tag, and deterioration of the resin molded article cannot be sufficiently determined.

### SUMMARY

According to an embodiment of the present disclosure, a resin molded article includes a body having a first discolor speed discolored by deterioration of the body, and a discoloring portion in the body and having a second discolor speed faster than the first discolor speed discolored by deterioration of a discoloring portion.

According to an embodiment of the present disclosure, a determining method includes forming a discoloring portion of a resin molded article, discoloring in the discoloring portion of the resin molded article, and determining the resin molded article to be deteriorated.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an apparatus according to an embodiment of the present disclosure;

FIG. 2A is a perspective view of a resin molded article in a non-deteriorated state;

FIG. 2B is a perspective view of a resin molded article in a deteriorated state;

FIG. 3 is a flowchart from a manufacturing process of a resin molded article to a reuse-and-recycling process;

FIG. 4A is a graph of a relation between stress and strain of the resin molded article without deterioration;

FIG. 4B is a graph of the relation between stress and strain in an elapsed state without deterioration; and

FIG. 5 is a perspective view of a resin molded article according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present disclosure, a resin molded article and a determining method for the deterioration of the resin molded article in a simple manner can be provided.

Embodiments of the present disclosure are described in detail with reference to the drawings. In the drawings, the same or like reference signs denote like elements having substantially the same or corresponding configurations, and descriptions thereof may be omitted.

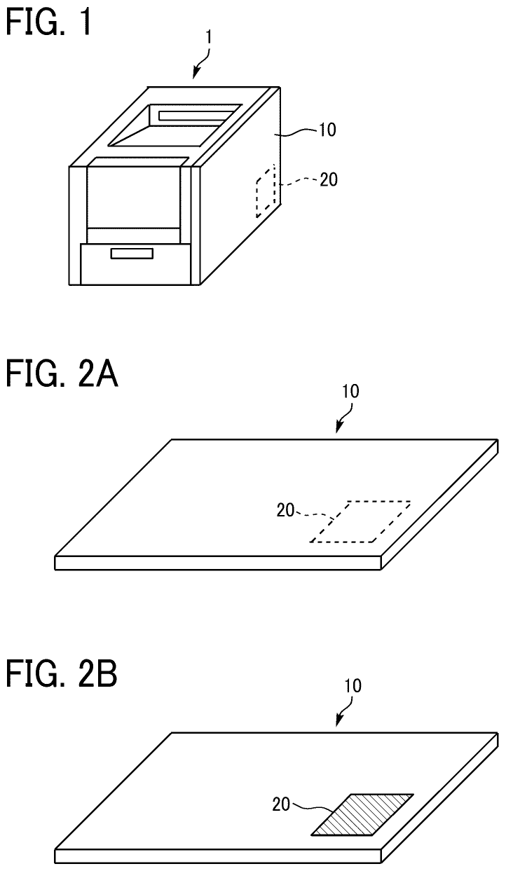

As illustrated in FIG. 1, an apparatus 1 includes a resin molded article 10 that is reusable. The resin molded article 10 is made of a predetermined resin material (e.g., polycarbonate (PC) resin, polyethylene terephthalate (PET) resin, or acrylonitrile butadiene styrene (ABS) resin). After the apparatus 1 has finished its service in the market, the apparatus 1 is collected from the market. The apparatus 1 is disassembled in a recycling factory to extract the resin molded article 10, and the degree of deterioration of the resin molded article 10 is determined. The reuse of the resin molded article 10 is determined depending on the degree of deterioration.

In the present embodiment, an image forming apparatus such as a printer is used as the apparatus 1. However, the apparatus 1 is not limited to the image forming apparatus, and any industrial product can be an object. In the present embodiment, a resin exterior cover is used as the resin molded article 10 that is reusable. However, the resin molded article 10 that is reusable is not limited to the resin exterior cover, and any resin molded article can be an object. Further, in the present embodiment, the resin molded article 10 is used as a component of the apparatus 1 distributed in the market. However, the resin molded article 10 may be separately used as a product to be distributed in the market. The industrial product includes an electric-and-electronic home appliance, an electronic product such as a communication device, a transportation apparatus such as an automobile, a vehicle, and an elevator, a small prefabricated product for a kitchen and a bathroom, a construction part for a house or a building, a civil engineering part such as a road sign, an exterior housing part for a daily product, a various kind of storage container, a toy, an audio device, and a beauty appliance. More specifically, the industrial product includes parts for an electric pot, a humidifier, a rice cooker, a rice-cake making machine, a coffee maker, a dishwashing-and-drying machine, and an air conditioner, a connector housing for electric connection of automobile wire harness, and a storage tray of a semiconductor part.

As illustrated in FIGS. 2A and 2B, the resin molded article 10 according to an embodiment of the present disclosure includes a discoloring portion 20 (printed portion) in a part of the resin molded article. The discoloring portion 20 is a portion that discolors before the resin molded article 10 discolors due to deterioration. In particular, the discoloring portion discolors with a color different from a color of other portions of the resin molded article 10 before the resin molded article 10 discolors due to deterioration. Specifically, when the resin molded article 10 has not deteriorated, the discoloring portion 20 has substantially the same color (or transparent color) as other portions (i.e., portions other than the discoloring portion 20). Thus, the discoloring portion 20 is hardly distinguishable from other portions. On the other hand, as illustrated in FIG. 2B, when other portions of the resin molded article 10 (i.e., the portion other than the discoloring portion 20) are going to discolor by an external factor such as heat, ultraviolet light, temperature, and humidity, the discoloring portion 20 largely discolors with a different color before the resin molded article 10 discolors. As a result, the discoloration of the discoloring portion 20 determines the reuse of the resin molded article 10. In other words, it is determined that the resin molded article 10 does not have a large deterioration and is reusable when the discoloring portion 20 does not discolors, and that the resin molded article 10 has a large deterioration and is not reusable when the discoloration portion 20 discolors.

In an embodiment of the present disclosure, a resin molded article includes a body having a first discolor speed discolored by deterioration of the body, and a discoloring portion in the body and having a second discolor speed faster than the first discolor speed discolored by deterioration of a discoloring portion.

In an embodiment of the present disclosure, in the resin molded article, the body discolors to a first color, and the discoloring portion discolors to a second color different from the first color.

In an embodiment of the present disclosure, in the resin molded article, the discoloring portion includes a printed portion, and the printed portion emerges by discoloring of the discoloring portion to the second color.

The discoloring portion 20 is formed so as to have a less environmental resistance than other portions of the resin molded article 10. In other words, the discoloring portion 20 is formed so that discoloration caused by an external factor such as heat, ultraviolet light, temperature, and humidity is promoted as compared with other portions. Specifically, an accelerator such as an ultraviolet absorber that promotes discoloration may be applied to or mixed with the discoloring portion 20, or a coating that is less likely to cause discoloration due to an external factor such as heat, ultraviolet light, temperature, and humidity may be applied to other portions other than the discoloring portion 20.

More specifically, as a determining method for deterioration of the resin molded article 10, a determining step determines that the resin molded article 10 has deteriorated when the discoloring portion 20 discolors. The determining step includes an excluding step for excluding the resin molded article 10 determined to have deteriorated as an object for reuse. Specifically, the resin molded article 10 that has determined to be discolored and have deteriorated is not reused but discarded as it is or recycled (i.e., returned to a resin material and used again as another resin molded article). By contrast, only the resin molded article 10 that is determined to be not discolored and have not deteriorated can be reused.

As described above, the resin molded article 10 according to an embodiment of the present disclosure can determine the deterioration of the resin molded article 10 by viewing the discoloration of the discoloring portion 20 formed in the resin molded article without using a measuring device, and thus the determination operation can be performed in a simple manner.

In an embodiment of the present disclosure, the discoloring portion 20 includes a printed portion and is formed so that the printed portion is visualized when the discoloring portion 20 discolors with a color different from a color of other portions. The printed portion includes readable information (at least one of material, grade, lot number, or manufacturing date of the resin molded article 10) on the resin molded article 10. The printed portion includes any one of a bar code, a two-dimensional barcode (e.g., a quick-response (QR) code (registered trademark)), a number, and a symbol. According to an embodiment of the present disclosure, the two-dimensional barcode is formed so as to emerge in the discoloring portion 20 as the deterioration of the resin molded article 10 progresses (see FIG. 2B).

In an embodiment of the present disclosure, in the resin molded article, the printed portion includes readable information on the resin molded article.

In an embodiment of the present disclosure, in the resin molded article, the readable information includes at least one of a material, a grade, a lot number, or a manufacturing date of the resin molded article.

In an embodiment of the present disclosure, in the resin molded article, the printed portion includes any one of a barcode, a two-dimensional barcode, a number, and a symbol.

More specifically, the discoloring portion 20 (printed portion) has the same color (or transparent color) as other portions when the resin molded article 10 has not deteriorated, and discolors depending on the accumulated amount or the instantaneous maximum value, which are factors that make the resin deteriorate, such as ultraviolet light, heat, temperature and humidity. As a result, the discoloring portion 20 (printed portion) is discolored due to deterioration under the influence of the above-described factor, and the two-dimensional barcode (printed portion) emerges. Since the accumulated amount and the maximum value of the ultraviolet light, heat, temperature, and humidity can be easily discriminated by the emerging of the printed portion, the deterioration of the resin molded article 10 can be determined. In other words, since the environmental resistance of the discoloring portion 20 (printed portion) against ultraviolet light, heat, temperature, and humidity is lower than the environmental resistance of the other resin portions, the discoloring portion 20 (printed portion) emerges due to deterioration. The discoloring portion 20 (printed portion) is a two-dimensional barcode (a barcode or a serial number) as a unique code for identifying the resin molded article 10, and the number of times the reuse and recycle of the resin molded article are done can be traced by managing the unique code by another system. The discoloring portion 20 (printed portion) records the original material, grade, lot number, and manufacturing date as the unique code, and information on the resin molded article 10 can be read. The resin molded article 10 includes such a discoloring portion 20 (printed portion) so that the environment in which the apparatus 1 including the resin molded article 10 has been used can be also known.

In an embodiment of the present disclosure, in the resin molded article, the discoloring portion has a less environmental resistance than other portions of the resin molded article.

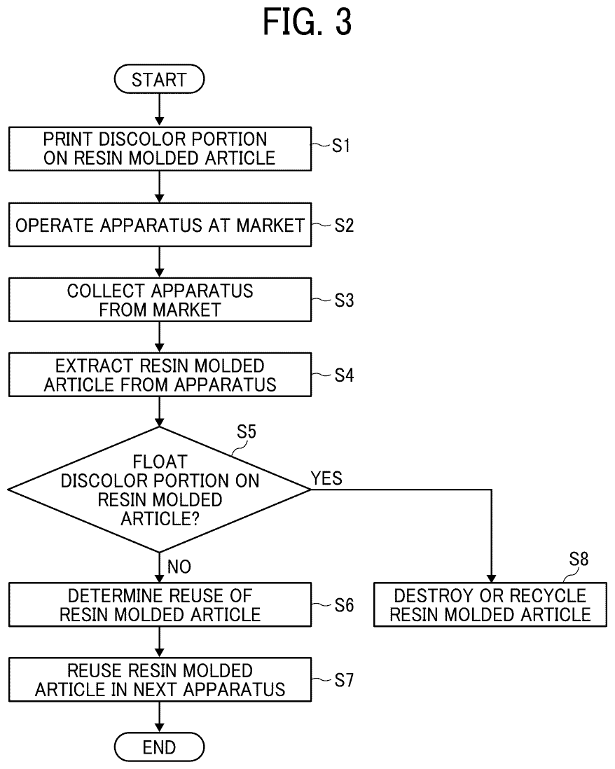

The flow from the manufacturing process of the resin molded article 10 to the reuse-and-recycling process will be described below with reference to FIG. 3. When the resin molded article 10 is molded in a manufacturing factory, a predetermined discoloring portion 20 (e.g., a two-dimensional barcode that emerges with discoloration) is formed in a part of the resin molded article 10 (step S1). The apparatus 1 including the resin molded article 10 in which the discoloring portion 20 has formed is shipped from the manufacturing factory, and is delivered to the market and operated (step S2). After the apparatus 1 has finished its service in the market, the apparatus 1 is collected from the market (step S3). The resin molded article 10 is extracted from the apparatus 1 and collected from the market (step S4). It is determined whether a two-dimensional barcode emerges with the discoloration of the discoloring portion 20 in the resin molded article 10 collected from the market (step S5). When it is not visually recognized that the discoloring portion 20 (two-dimensional barcode) emerges with discoloration, the resin molded article 10 is determined to be reusable as there is no unacceptable deterioration of the resin molded article 10, and the resin molded article 10 is assembled as it is to an apparatus 1 (steps S6 and S7) as a next object. By contrast, when it is visually recognized in step S5 that the discoloring portion 20 (two-dimensional barcode) emerges with discoloration, the resin molded article 10 is determined not to be reusable as there is an unacceptable deterioration of the resin molded article 10, and the resin molded article 10 is not reused and is discarded or recycled (steps S8).

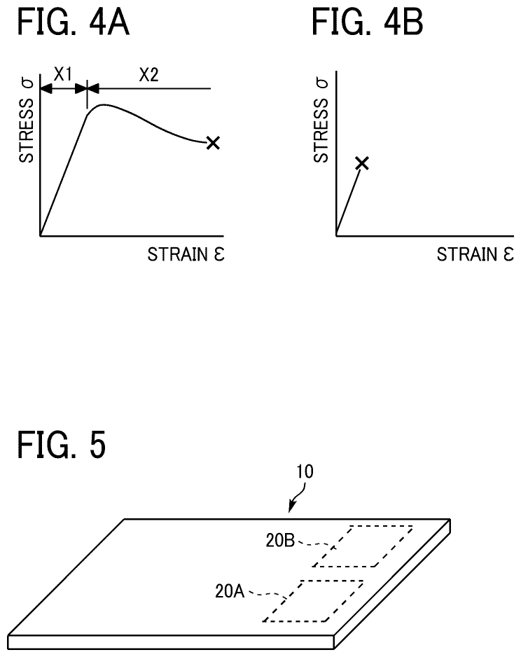

FIGS. 4A and 4B are graphs of the relation between strain ε and stress σ in the resin molded article 10. FIG. 4A is a graph of an initial state in which the resin molded article 10 has not deteriorated, and FIG. 4B is a graph of an elapsed state in which the resin molded article 10 has deteriorated. As illustrated in FIG. 4A, in the initial state, the resin molded article 10 has not deteriorated. When a force is applied to the resin molded article 10, the resin molded article 10 is elastically deformed up to a certain stress (see range X1). When a force is applied to the resin molded article 10 and the force exceeds the certain stress, the resin molded article 10 is plastically deformed. When the deformation is further increased, the resin molded article 10 is fractured (see range X2). The stress at the time of plastic deformation or fracture can be basically regarded as the strength of the material (resin molded article 10).

By contrast, as illustrated in FIG. 4B, when the strength of the resin molded article 10 deteriorates due to, for example, a decrease in the molecular weight of the resin material caused by heat, ultraviolet light, or humidity with elapsed time, the longitudinal elastic modulus (the slope of the graph in the clastic region) hardly changes. However, deterioration such as sudden fracture with almost no plastic deformation is likely to occur with a stress smaller than a stress in a state where there is no deterioration. The strength of the material (resin molded article 10) at this time is smaller than the strength in the state without deterioration (state illustrated in FIG. 4A). In the resin molded article 10 according to the present embodiment of the present disclosure, when the resin molded article 10 has deteriorated such that the relation between the strain ε and the stress σ is represented in FIG. 4B, the discoloring portion 20 emerges with discoloration, and thus, such a deteriorated state can be grasped at a glance.

### Modification

As illustrated in FIG. 5, the resin molded article 10 in the modification includes multiple discoloring portions (two discoloring portions including a first discoloring portion 20A and a second discoloring portion 20B in the present embodiment). The first discoloring portion 20A is a portion that discolors by an outer factor of at least one of heat, ultraviolet light, temperature, or humidity (e.g., heat and ultraviolet light). On the other hand, the second discoloring portion 20B is a portion that discolors by an outer factor of at least one of heat, ultraviolet light, temperature, or humidity other than the outer factor for the first discoloring portion 20A (e.g., heat and ultraviolet light). As described above, the resin molded article 10 includes the multiple discoloring portions including the first discoloring portion 20A and the second discoloring portion 20B that have different outer factors for discoloration with each other. Accordingly, the cause of deterioration can be specified and the property of the resin molded article 10 can be grasped. For example, in the above-described example, when discoloration of the first discolored portion 20A is visible, it can be determined that the resin material is difficult to reuse because of advanced strength deterioration caused by heat or ultraviolet light, and when discoloration of the second discolored portion 20B is visible, it can be determined that the resin material is difficult to reuse because of advanced strength deterioration due to accelerated hydrolysis of the resin material caused by temperature or humidity.

In an embodiment of the present disclosure, in the resin molded article, the discoloring portion includes multiple discoloring portions including a first discoloring portion discolors by a first outer factor including at least one of heat, ultraviolet light, temperature, or humidity, and a second discoloring portion discolors by a second outer factor including at least one of heat, ultraviolet light, temperature, or humidity, other than the first outer factor.

In an embodiment of the present disclosure, in the resin molded article, reusability of the resin molded article is determined based on a discoloration of the discoloring portion.

As described above, the resin molded article 10 according to an embodiment of the present disclosure is a resin molded article made of a predetermined resin material, and includes a discoloring portion 20 that discolors before other portions of the resin molded article 10 discolor due to deterioration in the resin molded article 10. Accordingly, the deterioration of the resin molded article 10 can be determined in a simple manner.

It is obvious that the present disclosure is not limited to the present embodiment, and the present embodiment can be modified as appropriate in addition to the modifications suggested in the present embodiment within the scope of the technical idea of the present disclosure. In addition, the number, position, and shape of the constituent members described above are not limited to those in the present embodiment, and can be set to the number, position, or shape preferable for conducting the present embodiment.

Aspects of the present disclosure are, for example, as follows.

### First Aspect

A resin molded article includes a body having a first discolor speed discolored by deterioration of the body, and a discoloring portion in the body and having a second discolor speed faster than the first discolor speed discolored by deterioration of a discoloring portion.

### Second Aspect

In the resin molded article according to the first aspect, the body discolors to a first color, and the discoloring portion discolors to a second color different from the first color.

### Third Aspect

In the resin molded article according to the first or second aspect, the discoloring portion includes a printed portion, and the printed portion emerges by discoloring of the discoloring portion to the second color.

### Fourth Aspect

In the resin molded article according to the third aspect, the printed portion includes readable information on the resin molded article.

### Fifth Aspect

In the resin molded article according to the fourth aspect, the readable information includes at least one of a material, a grade, a lot number, or a manufacturing date of the resin molded article.

### Sixth Aspect

In the resin molded article according to the fourth aspect, the printed portion includes any one of a barcode, a two-dimensional barcode, a number, and a symbol.

### Seventh Aspect

In the resin molded article according to any one of the first to sixth aspects, the discoloring portion includes multiple discoloring portions including a first discoloring portion discolors by a first outer factor including at least one of heat, ultraviolet light, temperature, or humidity, and a second discoloring portion discolors by a second outer factor including at least one of heat, ultraviolet light, temperature, or humidity, other than the first outer factor.

### Eighth Aspect

In the resin molded article according to any one of the first to seventh aspects, the discoloring portion has a less environmental resistance than other portions of the resin molded article.

### Ninth Aspect

In the resin molded article according to any one of the first to eight aspects, reusability of the resin molded article is determined based on a discoloration of the discoloring portion.

### Tenth Aspect

A determining method includes forming a discoloring portion of a resin molded article, discoloring in the discoloring portion of the resin molded article, and determining the resin molded article to be deteriorated.

### Eleventh Aspect

The determining method according to the ninth aspect further includes excluding the resin molded article determined to be deteriorated in the determining from reuse.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A resin molded article comprising:
a body having a first discolor speed discolored by deterioration of the body; and
a discoloring portion in the body and having a second discolor speed faster than the first discolor speed discolored by deterioration of a discoloring portion.

2. The resin molded article according to claim 1,
wherein the body discolors to a first color; and
the discoloring portion discolors to a second color different from the first color.

3. The resin molded article according to claim 2,
wherein the discoloring portion includes a printed portion, and
the printed portion emerges by discoloring of the discoloring portion to the second color.

4. The resin molded article according to claim 3,
wherein the printed portion includes readable information on the resin molded article.

5. The resin molded article according to claim 4,
wherein the readable information includes at least one of a material, a grade, a lot number, or a manufacturing date of the resin molded article.

6. The resin molded article according to claim 4,
wherein the printed portion includes any one of a barcode, a two-dimensional barcode, a number, and a symbol.

7. The resin molded article according to claim 1,
wherein the discoloring portion includes multiple discoloring portions including:
a first discoloring portion discolors by a first outer factor including at least one of heat, ultraviolet light, temperature, or humidity; and
a second discoloring portion discolors by a second outer factor including at least one of heat, ultraviolet light, temperature, or humidity, other than the first outer factor.

8. The resin molded article according to claim 1,
wherein the discoloring portion has a less environmental resistance than other portions of the resin molded article.

9. The resin molded article according to claim 1,
wherein reusability of the resin molded article is determined based on a discoloration of the discoloring portion.

10. A determining method comprising:
forming a discoloring portion of a resin molded article;
discoloring in the discoloring portion of the resin molded article; and
determining the resin molded article to be deteriorated.

11. The determining method according to claim 10, further comprising
excluding the resin molded article determined to be deteriorated in the determining from reuse.
